(19) United States
(12) Patent Application Publication
(10) Pub. No.: US 2005/0124200 A1
(43) Pub. Date: Jun. 9, 2005

(54) Plug for avoiding unintended disconnection of electrical power

(76) Inventors: Geoffrey H. Nudd, Round Rock, TX (US); William C. Milks III, Los Altos, CA (US)

Correspondence Address: William C. Milks, III;RUSSO & HALE LLP, 401 Florence Street, Palo Alto, CA, 94301, US

(21) Appl. No.: 10/729,806

(22) Filed: Dec. 5, 2003

(51) Int. Cl. H01R 4/50

(52) U.S. Cl. 439/346

(57) ABSTRACT

An apparatus and method are provided for substantially avoiding the inadvertent disconnection or dislodgment of an electrically powered device, such as a computer or television set or vacuum cleaner, from a source of electrical power. The apparatus includes an electrical male plug that has prongs configured to increase the tension between the electrical male plug and the sockets of an electrical power outlet, or an electrical female plug that has female contacts disposed in sockets and configured to increase the tension between female contacts and the male contacts of the electrically powered device. The apparatus and method alternatively provide an adapter having an increased tension electrical male plug at one end and a standard electrical female receptacle at a second end, and a mechanism that locks a standard electrical male plug to the standard electrical female receptacle of the adapter. The apparatus and method also alternatively provide a standard electrical female receptacle at one end, and a mechanism that locks a standard electrical male plug to the standard electrical female receptacle to provide a locking female outlet. The adapter or locking female outlet is attachable to a standard electrical male plug for preventing the inadvertent disconnection or dislodgment of an electrically powered device plugged into the standard electrical female receptacle of the adapter or locking female outlet.

### BACKGROUND OF THE INVENTION

1. Field of the Invention

The present invention relates generally to electrically powered equipment, and, more particularly, to preventing the inadvertent or unauthorized disconnection of the equipment from a source of electrical power. Specifically, one embodiment of the present invention provides an apparatus and method for retaining the plug through which electrical power is connected to an electrically powered apparatus, for example, a computer or television set or vacuum cleaner, to substantially avoid unintended disconnection of electrical power supplied from a standard electrical power outlet.

2. Description of the Prior Art

U.S. Patents

| | | |
|---|---|---|
| 3,890,025 | June, 1975 | Gray |
| 4,063,110 | December, 1977 | Glick |
| 4,111,509 | September, 1978 | Novak |
| 4,488,764 | December, 1984 | Pfenning, et al. |
| 4,673,230 | June, 1987 | Baumgart |
| 4,782,971 | November, 1988 | Hill |
| 4,838,052 | June, 1989 | Williams, et al. |
| 5,249,976 | October, 1993 | Brock |
| D344,443 | February, 1994 | Ashby |
| 5,434,368 | July, 1995 | Hoffman |
| 5,507,656 | April, 1996 | Ales |
| 5,731,763 | March, 1998 | Herweck, et al. |
| 5,480,318 | January, 1996 | Garrison |
| 5,829,999 | November, 1998 | Macleod |
| 6,060,979 | May, 2000 | Eichsteadt |
| 6,080,002 | June, 2000 | Macleod, et al. |
| 6,142,797 | November, 2000 | Bailey |
| 6,454,579 | September, 2002 | Davis |

Foreign Patent

| | | |
|---|---|---|
| 11-237176 | August, 1999 | JP |

For business and/or personal reasons, it is often desirable to ensure that an electrically powered device is continually plugged in to an electrical power outlet. For example, a person working on his or her computer typically wants to avoid productivity losses that would occur if the plug through which power is supplied to the computer were to accidentally be removed or dislodged from the source of electrical power. Similarly, electrically powered devices used in industry, such as manufacturing machinery, must retain an electrical connection to avoid power outages that result in costly production losses. It is therefore desirable to employ a device for preventing the inadvertent or unauthorized disconnection of the plug through which power is supplied to an electrically powered device, such as a computer or industrial machinery, from an electrical power outlet.

Known devices to prevent the in advertent or unauthorized disconnection of the plug through which power is supplied to an electrically powered device, such as a computer or industrial machinery, from an electrical power outlet typically require a housing around the electrical power outlet or plug, or are constructed to prevent unauthorized use of the electrical device, rather than inadvertent disconnection or dislodgment of the electrical device from the electrical power source.

For example, U.S. Pat. No. 4,063,110 to Glick discloses a mechanism for preventing unauthorized use of an electrical plug. The mechanism comprises a housing that receives the plug and a lock for preventing the plug from being electrically connected to an electrical power outlet, or to prevent unauthorized or inadvertent removal from the electrical power outlet after the plug is inserted.

U.S. Pat. No. 4,673,230 to Baumgart also discloses a device for preventing unauthorized use of a plug having a housing that receives the plug and a lock for preventing the plug from being electrically connected to an electrical power outlet.

U.S. Pat. No. 4,782,971 to Hill discloses a lock box for a plug, which has two parts that slide together and which receive a plug therebetween and which are interconnected by a key lock to prevent the plug from being electrically connected to an electrical power outlet.

Additionally, U.S. Pat. No. 5,434,368 to Hoffman discloses a device for controlling the use of electrical connectors and which has a key pad to prevent unauthorized use.

U.S. Pat. No. 5,507,656 to Ales discloses a housing for receiving a plug and a lock to prevent the plug from being electrically connected to an electrical power outlet.

U.S. Pat. No. 6,142,797 to Bailey discloses a plug lock that has a key operated cam to engage a plug and prevent the plug from being electrically connected to an electrical power outlet.

U.S. Pat. No. 6,454,579 to Davis discloses a locking device having a housing with a hinged cover that can only be opened with a coded key pad. The housing has contacts that enable the plug to be connected through the housing to a standard electrical power outlet, or enable the plug to be disconnected from the contacts in the housing and not allow the plug to be electrically connected to a standard electrical power outlet.

Other known devices to prevent the inadvertent or unauthorized disconnection of the plug of an electrically powered device, such as a computer or industrial machinery, from an electrical power outlet may potentially damage the electrical power outlet or the electrical device due to their locking nature and are not accepted by standards bodies such as Underwriters Laboratories. Also, these known mechanisms often have multiple moving parts, which increase manufacturing cost.

For example, U.S. Pat. Nos. 6,080,002 and 5,829,999 to Macleod, et al., disclose a plug that is equipped with a grounding pin comprising an elongate metal body defining a groove for holding captive a split band of a molded plastic material, which has inwardly facing nodes that are receivable in a transverse passage through the body. The body further defines a longitudinal threaded bore for receiving a threaded shank having a tapered tip which, in use, is seated between the inner nodes on the band. When the pin is inserted into a corresponding socket of an existing electrical power outlet, and a circular cap on the exposed end of the threaded shank is rotated, the tip of the shank bears against the nodes on the band, thereby expanding the band radially outwardly until it frictionally engages an adjacent portion of the socket of the electrical power outlet in which the pin is inserted. The pin, together with any electrically conducting prongs associated with the same plug, are hence better secured against inadvertent extraction from their respective sockets.

U.S. Pat. No. 5,249,976 to Brock also discloses a plug for three-wire line cords including a plug body having a U-shaped grounding pin. A rise pin is disposed between opposing walls of the U-shaped grounding pin. A locking element extending through the plug body includes a threaded proximal portion and a flat distal portion, the distal portion having a ramp disposed over the rise pin and a serrate edge opposite the ramp with the distal portion disposed within the grounding pin opposing walls. A locking knob is threaded onto the proximal portion of the plug. With the plug inserted in an electrical power outlet, the knob is rotated clockwise to draw the flat distal portion rearwardly, causing the ramp to ride up the rise pin to in turn cause the serrate edge to grip the inner surface of the grounding socket. Rotating the knob counterclockwise releases the serrate edge to permit withdrawal of the plug from the electrical power outlet.

U.S. Pat. No. 4,111,509 to Novak discloses a plug having a grounding pin supported in the plug body for axial shifting. The end of the grounding pin extending through the plug body is threaded to engage a turn knob, and the other end of the grounding pin extending from the plug body for insertion in the electrical power outlet is adapted to carry spring filaments that are supported to radially arch due to the axial movement of the grounding pin in response to the rotation of the knob and thereby better secure the plug in the electrical power outlet.

U.S. Pat. No. 3,890,025 to Gray discloses a standard, grounded, three-conductor male electrical plug constructed to positively lock in place in a complementary female socket of an electrical power outlet by friction pressure produced by a single tapered cam member that is connected to the plug body in such a way as to move longitudinally and to rotate within a split, scored grounding pin of the plug.

U.S. Pat. No. 5,480,318 to Garrison discloses a three-conductor male plug including in the grounding pin a spring-biased catch for engaging the walls of a female electrical power outlet and locking the plug in the outlet. An aperture in the plug enables a non-conductive tool to move the catch against the spring bias and away from the walls of the socket of the electrical power outlet to unlock the plug and permit removal from the outlet.

Known devices for locking or capturing a plug in an electrical power outlet have many disadvantages and limitations and are relatively costly to manufacture in comparison with standard electrical plugs that can be relatively easy to inadvertently dislodge from a source of electrical power. There is a long felt but unmet need for an economical electrical plug that substantially prevents the plug from being disconnected or dislodged from an electrical power source and yet fully meets the requirements of standards bodies for plugs. It is to such a plug that the present invention is directed.

### SUMMARY OF THE INVENTION

It is therefore an object of the present invention to provide a new and improved electrical plug that substantially prevents inadvertent disconnection from a source of electrical power.

It is another object of the present invention to provide a new and improved increased tension electrical plug.

It is a further object of the present invention to provide a new and improved increased tension electrical plug that is easy to operate.

It is another object of the present invention to provide a new and improved increased tension electrical plug that substantially prevents inadvertent disconnection from a standard electrical power outlet.

It is an additional object of the present invention to provide such a new and improved increased tension electrical plug that does not require a housing or installation of a fixture.

It is a further object of the present invention to provide a new and improved increased tension electrical plug that will operate with or without additional locking means to prevent inadvertent and unauthorized disconnection from an electrical power outlet.

It is still another object of the present invention to provide a new and improved increased tension electrical plug that may be used with a variety of multi-prong plugs.

It is another object of the present invention to provide a new and improved increased tension electrical plug that is of durable and reliable construction.

It is another object of the present invention to provide a new and improved increased tension electrical plug that will not potentially damage the electrically powered device or electrical power outlet to which the electrical device is connected.

It is a further object of the present invention to provide an increased tension electrical plug that has an innovative simplicity of design and function.

It is a still further object of the present invention to provide a new and improved increased tension electrical plug that may be easily and efficiently manufactured and marketed.

Still another object of the present invention is to provide an increased tension electrical plug that requires a minimal number of parts.

It is a further object of the present invention to provide an increased tension electrical male plug that may be locked to a standard electrical male plug to give a standard electrical plug the aforementioned improvements in functionality.

It is a further object of the present invention to provide a mechanism that locks a standard electrical male plug to a female receptacle to allow one electrical cord to be locked to another electrical cord to increase the overall length of the cord without introducing the risk of inadvertent disconnection or dislodgement of the plug through which electrical power is supplied to an electrically powered device, for example, a computer or television set or vacuum cleaner.

It is an additional object of the present invention to provide a mechanism that locks a standard electrical male plug to a female receptacle that is easy to operate.

It is further object of the present invention to provide a mechanism that locks a standard electrical male plug to a female receptacle that is of durable and reliable construction.

It is an additional object of the present invention to provide a mechanism that locks a standard electrical male plug to a female receptacle that has an elegant simplicity of design and function.

It is further object of the present invention to provide a mechanism that locks a standard electrical male plug to a female receptacle that may be easily manufactured and marketed.

Still another object of the present invention is to provide a mechanism that locks a standard electrical male plug to a female receptacle that requires a minimal number of parts.

In accordance with one embodiment of the present invention, an apparatus and method are provided for substantially preventing the inadvertent disconnection or dislodgment of a plug through which electrical power is supplied to an electrically powered device, for example, a computer or television set or vacuum cleaner. One embodiment of the present invention provides an electrical male plug that has prongs that increase the tension between the electrical male plug and the sockets of a standard electrical power outlet into which the plug is selectively inserted. The apparatus and method to increase tension between the electrical male plug and the electrical power outlet may include, individually or in combination: a) recurving or arching a portion(s) of the prong(s) or splitting and arching outwardly and/or inwardly a portion(s) of the prong(s); b) roughening the surface of the prong(s); c) splaying and/or spreading the prongs inwardly or outwardly to increase tension between the electrical male plug and the sockets of the electrical power outlet and including a mechanism that reduces the splaying and/or spreading of the prongs to enable the electrical male plug to be more easily inserted into or removed from the electrical power outlet, all as will be detailed in the specification that follows hereafter.

Another embodiment of the apparatus and method in accordance with the present invention provides an adapter comprising an electrical male plug with the aforementioned improvements and a female electrical receptacle, and a mechanism that locks a standard electrical male plug for an electrically powered device to the female electrical receptacle of the adapter. Preferably, the locking mechanism may also be released. Accordingly, the adapter is a combination of the increased tension electrical male plug and the female electrical receptacle with means to selectively lock in a standard electrical male plug. The adapter may be connected to a standard electrical power outlet to increase tension between the adapter and the electrical power outlet. The adapter thus increases tension between a standard electrical male plug and an electrical power outlet that supplies electrical power to the electrically powered device, all as will be detailed in the specification that follows hereafter.

In an alternative embodiment of the present invention, a locking mechanism without the increased tension male end may be provided (for example, a female receptacle is provided for locking one extension cord to another extension cord). That is, an alternative embodiment of the apparatus and method in accordance with the present invention provides a female electrical receptacle with a mechanism that locks a standard electrical male plug for an electrically powered device to the female electrical receptacle.

In accordance with another embodiment of the present invention, an electrical female plug is equipped with one or more increased tension sockets for substantially preventing the inadvertent disconnection or dislodgment of the plug through which electrical power is supplied to an electrically powered device, for example, a computer or television set or vacuum cleaner.

In accordance with other embodiments of the present invention, locking means may be additionally provided to prevent unauthorized disconnection of the increased tension plug through which power is supplied to the electrically powered apparatus. The locking means may comprise a housing that encloses the increased tension plug and is secured by a lock.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements.

FIG. 1 is an isometric view of one embodiment of the apparatus in accordance with the present invention;

FIG. 2 is an isometric view of an alternative embodiment of the apparatus shown in FIG. 1;

FIG. 3 is a plan view of further alternative embodiments of the apparatus in accordance with the present invention;

FIG. 4 is an isometric view of another embodiment of the apparatus in accordance with the present invention;

FIG. 5 is an isometric view of an alternative embodiment of the apparatus in accordance with the present invention;

FIG. 6 is an isometric view of yet another alternative embodiment of the apparatus in accordance with the present invention;

FIG. 7 is a rear isometric view of one embodiment of an adapter in accordance with the present invention;

FIG. 8 is a side isometric view of the apparatus shown in FIG. 7;

FIG. 9 is a rear isometric view of an alternative embodiment of a female electrical receptacle with a mechanism that locks a standard electrical male plug for an electrically powered device to the female electrical receptacle;

FIG. 10 is an isometric view of an alternative embodiment of a female electrical receptacle with a mechanism that locks a standard electrical male plug for an electrically powered device to the female electrical receptacle, with said mechanism open and unlocked;

FIG. 11 is an isometric view of the embodiment of the female electrical receptacle with a mechanism that locks a standard electrical male plug for an electrically powered device to the female electrical receptacle shown in FIG. 10, with said mechanism partially closed and locked;

FIG. 12 is a top plan view of a prong having a single arch comprising one embodiment of the present invention;

FIG. 13 is a top plan view of a prong having a single asymmetrical arch comprising one embodiment of the present invention;

FIG. 14 is a top plan view of a recurved prong comprising one embodiment of the present invention;

FIG. 15 is a top plan view of a prong having opposite facing arches comprising one embodiment of the present invention;

FIG. 16 is a top plan view of a prong having more than one arch comprising one embodiment of the present invention;

FIG. 17 is a top plan view of a prong having more than one opposite facing arch comprising one embodiment of the present invention;

FIG. 18 is a top plan view of a doubly arched grounding pin comprising one embodiment of the present invention;

FIG. 19 is a top plan view of a prong slit and formed to have a first arched portion extending in a first lateral direction and a second arched portion extending in a second lateral direction comprising one embodiment of the present invention;

FIG. 20 is an isometric view of a prong with an arched edge comprising one embodiment of the present invention;

FIG. 21 is a cross-sectional view of an alternative embodiment of the apparatus in accordance with the present invention comprising an electrical female plug having arched contacts; and

FIG. 22 is a cross-sectional view of an alternative embodiment of the apparatus in accordance with the present invention comprising an electrical female plug having cantilever contacts.

### DETAILED DESCRIPTION OF THE PREFERRED EMBODIMENTS

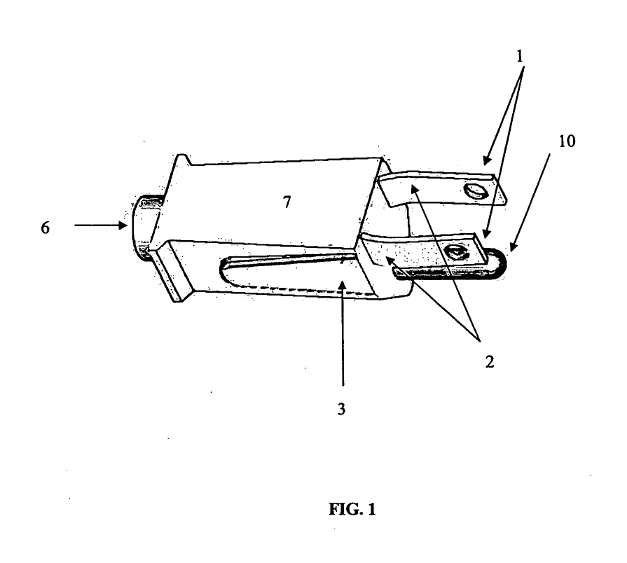

Referring now to the drawing, FIG. 1 shows an electrical male plug 3 comprising a pair of prongs or blades 1 and a grounding prong 10. Recurvature 2 of at least one and preferably both of the prongs 1 of the electrical male plug 3 is provided to increase tension between the prongs 1 and corresponding sockets (not shown) of a standard female electrical power outlet (not shown), when the prongs 1 of the plug are selectively inserted into and reside in the sockets of the electrical power outlet. Preferably, the prongs 1 and 10 are nominally separated from each other at their distal ends by a distance or spacing substantially equal to that of the prongs of a standard electrical male plug and substantially corresponding to the spacing of the sockets of a standard electrical power outlet.

In operation, the electrical male plug 3 is selectively inserted into a standard electrical power outlet. The recurvature 2 of the one or more prongs 1 increases the tension between the prongs 1 and the sockets of the electrical power outlet and substantially prevents unintended disconnection or dislodgment of the plug.

In accordance with a modification of the electrical male plug 3 shown in FIG. 1, the prongs 1 and/or 10 may be roughened to also increase friction between the prongs 1 and/or 10 and the sockets of the electrical power outlet into which the plug is selectively inserted. For example, the prongs 1 and/or 10 can be sandblasted, etched, machined, or cast to have a roughened surface.

Also, in accordance with another modification of the electrical male plug 3 shown in FIG. 1, a body 7 of the electrical male plug 3 may be constructed of a resilient material with the distal ends of the prongs 1 spread or splayed inwardly or outwardly beyond a standard spacing, and the ground prong 10 positioned relative to the prongs 1 at a distance less than standard. For example, the resilient material may be rubber, elastomer, or plastic. In operation, the male plug body 7 may be compressed by squeezing the body to alter the separation of the encapsulated portion of the prongs 1 and increase the separation of the encapsulated portion of the ground prong 10 from the prongs 1 sufficiently for the prongs 1 and 10 to be inserted into the sockets of a standard electrical power outlet. The non-standard default position of the prongs 1 and ground prong 10 and the resilient characteristic of the male plug body 7 increase tension between the electrical male plug 3 and the sockets of the standard electrical power outlet (not shown).

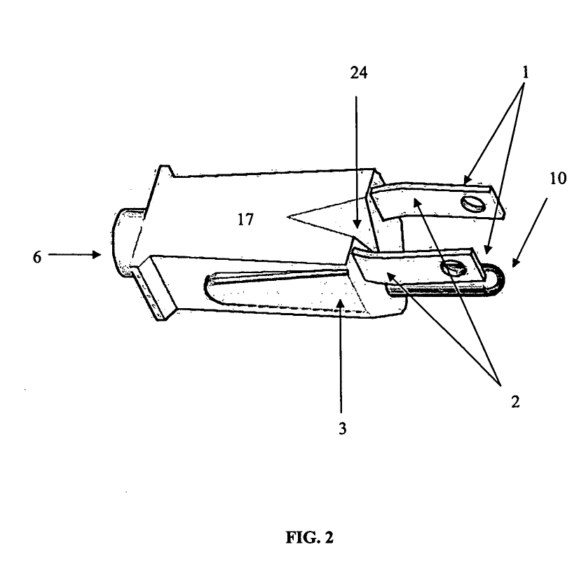

FIG. 2 illustrates an alternative embodiment of the apparatus shown in FIG. 1. As shown in FIG. 2, a cavity 24, for example, a triangular cavity, is provided in a body 17 of the electrical male plug 3. The spacing difference between the prongs 1 and the sockets of the electrical power outlet may be reduced by squeezing the male plug body 17 to thus decrease the width of the cavity 24 in the body of the plug, modifying the spread of the prongs 1 to the standard spacing for easier insertion into and removal from a standard electrical power outlet. The cavity 24 in the male plug body 17 eases movement of the prongs 1 in response to inward pressure on the sides of the plug 3.

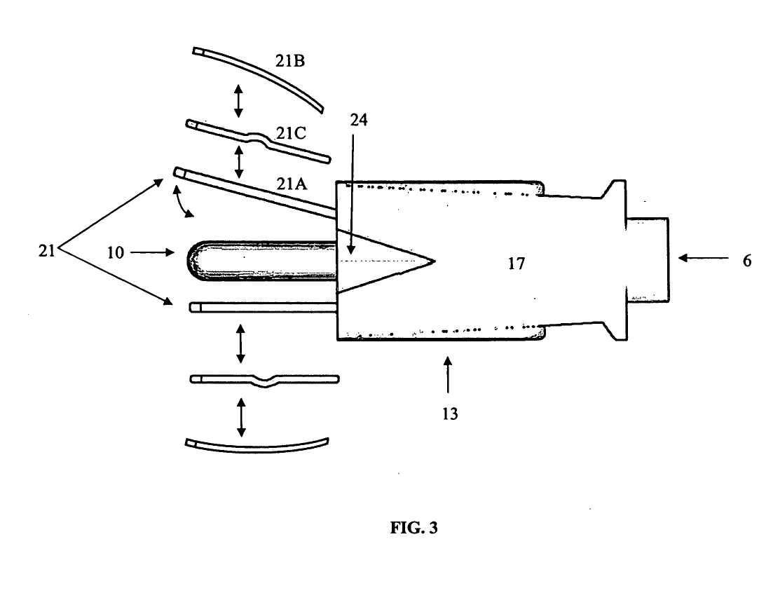

FIG. 3 shows a bottom plan view of various contemplated alternative embodiments of an electrical male plug 13 having prongs 21 that comprise prongs selected from among straight prongs 21A, recurved prongs 21B, and arched prongs 21C. One of the prongs 21 may be configured as a prong 21A, 21B, or 21C, and the other prong 21 may be the same or differently configured. As shown in FIG. 3, one of the prongs 21 may be splayed, and the spacing difference between the prongs 21 and the sockets of an electrical power outlet may be altered by squeezing the male plug body 17 to thus reduce the width of the cavity 24 in the body of the plug, modifying the spread of the prongs 21 to the standard spacing for easier insertion into and removal from a standard electrical power outlet. The cavity 24 in the male plug body 17 eases movement of the prongs 21 in response to inward pressure on the sides of the plug 13.

In one contemplated modification of the various embodiments of the electrical male plug 13 shown in FIG. 3, the male plug body 17 constructed of resilient material may or may not comprise the cavity 24, and the length and orientation of the prongs 21 may be asymmetrical. For example, one prong 21 may be splayed and the other prong 21 not splayed, with the splayed prong being longer than the non-splayed prong. In operation, the distal end of the longer splayed prong 21 may be first inserted into one socket of a standard electrical power outlet (not shown) and then lateral force applied to create leverage to move the distal end of the non-splayed prong 21 to a standard spacing to enable complete insertion into the standard electrical power outlet.

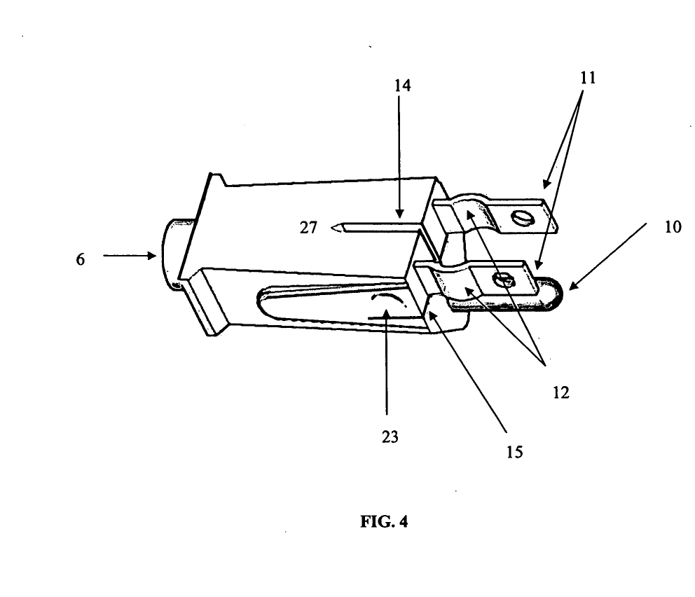

Another embodiment in accordance with the present invention is shown in FIG. 4 to increase the tension between prongs 11 of an electrical male plug 23 and the sockets (not shown) of a standard electrical power outlet (not shown). The prongs 11 of the electrical male plug 23 shown in FIG. 4 comprises arches 12. Preferably, the prongs 11 are also nominally separated from each other by a distance or spacing greater than that of a standard electrical male plug. Because the spacing between the prongs 11 of the electrical male plug 23 is greater than the spacing between the sockets of a standard electrical power outlet, the plug comprises means to enable decreasing the separation of the prongs so that the plug can be selectively inserted into the sockets of a standard electrical power outlet.

Accordingly, as shown in FIG. 4, a male plug body 27 of the electrical male plug 23 may be provided with one or more slits 14 and 15 in the body. The spacing difference between the prongs 11 and the sockets of the electrical power outlet may be reduced by squeezing the male plug body 27 to thus close the slit 14 in the body of the plug, modifying the spread of the prongs 11 to the standard spacing for easier insertion into and removal from the sockets of a standard electrical power outlet. The slit 15 in the male plug body 27 eases movement of the prongs 11 in response to inward pressure on the sides of the plug 23. Although the slit 14 is shown to comprise a rectangular cavity, the slit may be any shape that enables compression and ease of manufacture, such as a triangular slit.

In operation, the resilient or slit body portion 27 of the electrical male plug 23 acts as a spring mechanism to move the prongs 11 to a non-standard spacing. The male plug body 27 is squeezed to reduce the spacing of the prongs 11 so that the prongs can be inserted into the sockets of a standard electrical power outlet. After the electrical male plug 23 is inserted and released, the spring mechanism further increases tension between the prongs 11 of the plug and the sockets of the standard electrical power outlet to substantially avoid unintended disconnection or dislodgment of the plug through which electrical power is connected to an electrically powered device via an electrical cable 6.

FIG. 5 shows an alternative embodiment of an electrical male plug 33 having recurvature 2 for the prongs 1, that increases the tension between the plug and the sockets of a standard electrical power outlet. As shown in FIG. 5, the electrical male plug 33 has a rectangular hollowed region 34 provided in a male plug body 37 to act as a spring mechanism to spread the prongs 1 to a distance differing from that of a standard electrical male plug. The difference in spacing between the prongs 1 and the sockets of a standard electrical power outlet may be reduced by squeezing the sides of the electrical male plug 33 to reduce the cross-section of the hollowed portion 34 in the male plug body 37 of the plug, modifying the spacing of the prongs 1 to a spacing for easier insertion into and removal from a standard electrical power outlet.

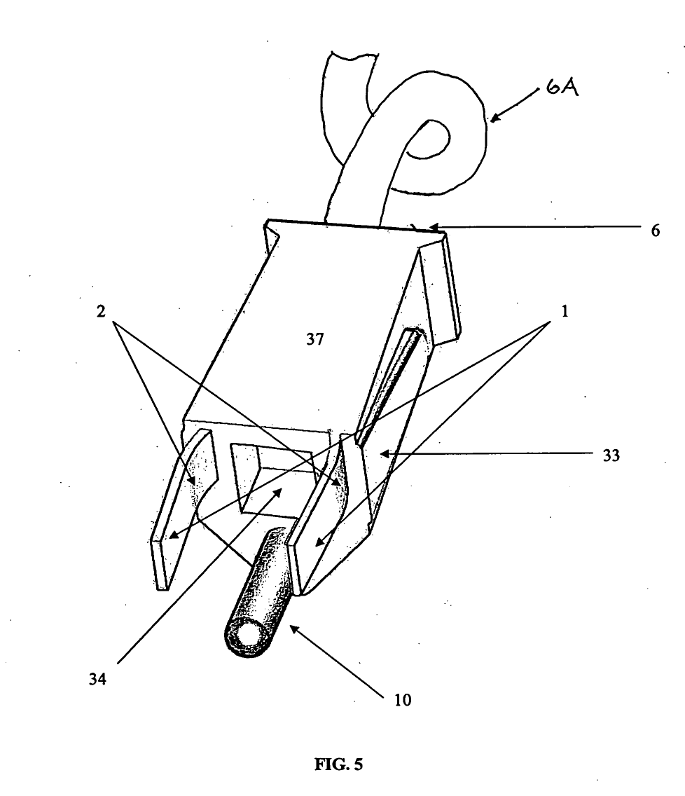

FIG. 6 shows an alternative embodiment of an electrical male plug 43 having recurvature 2 for the prongs 1, that increases the tension between the plug and the sockets of a standard electrical power outlet. As shown in FIG. 6, the electrical male plug 43 has a hollowed region 44 provided in a male plug body 47 having a polygonal cross-section that is other than rectangular to act as a spring mechanism to spread the prongs 1 and ground prong 10 to a spacing differing from that of a standard electrical male plug. The difference in spacing between the prongs 1 and 10 and the sockets of a standard electrical power outlet may be reduced by squeezing the sides of the electrical male plug 43 to reduce the cross-section of the hollowed portion 44 in the male plug body 47 of the plug, and to increase the distance between the prongs 1 and ground prong 10, thus modifying the spacing of the prongs 1 and ground prong 10 to a spacing for easier insertion into and removal from a standard electrical power outlet. For example, the pentagonal shape of the hollowed region 44 shown in FIG. 6 contributes to a greater displacement of the ground prong 10 relative to the prongs 1 when the male plug body 47 is squeezed for easier insertion into and removal of the electrical male plug 43 from the sockets of the electrical power outlet.

FIGS. 1-6 illustrate that a variety of male plug body shapes 7, 17, 27, 37, or 47 are contemplated, by which the body of the electrical male plug 3, 13, 23, 33, or 43 may act as a spring mechanism to move the prongs 1, 11, or 21 and/or ground prong 10 to a non-standard spacing, and the body of the plug may be squeezed to move the prongs to a standard spacing for easier insertion into and removal from the sockets of an electrical power outlet. For example, the body of the plug may be constructed of a sufficiently resilient material such that no cuts or separations are required in the male plug body 7 in order for the body to act as a spring to increase tension between the prongs and the sockets of the electrical power outlet. Additionally, one or more slits or hollowed regions 14, 15, 24, 34, or 44 may be provided to reduce spring force. Alternatively, it will be understood by persons skilled in the art that the slits or hollowed regions 14, 15, 24, 34, or 44 may be internal to the male plug body such that the default position of the prongs 1, 11, or 21 and/or 10 is non-standard and such that a force exerted on the male plug body moves the prongs to a standard spacing for easier insertion and removal of the plug from an electrical power outlet. Other types of springs (not shown) are contemplated to exert a force on the prongs 1, 11, or 21 and/or 10 to move them to a non-standard spacing, as will be understood by those skilled in the art. FIGS. 1-6 also illustrate that a variety of prong configurations may be used to further increase tension between the electrical male plug 3, 13, 23, 33, or 43 and the sockets of the electrical power outlet. The spring mechanism preferably operates in conjunction with the recurvature 2 or arches 12 and/or inward or outward splaying to increase the tension between the electrical male plug 3, 13, 23, 33, or 43 and the sockets of a standard electrical power outlet to avoid unintended disconnection or dislodgment of the plug through which electrical power is connected to an electrically powered device via the electrical cable 6.

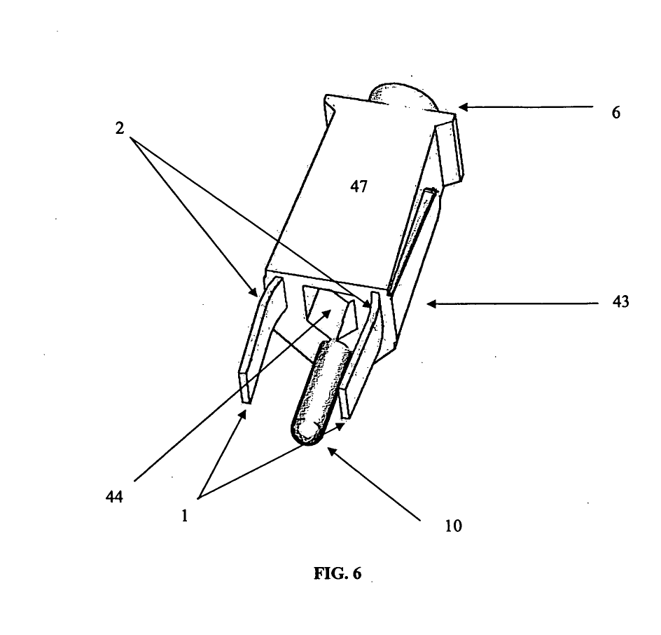

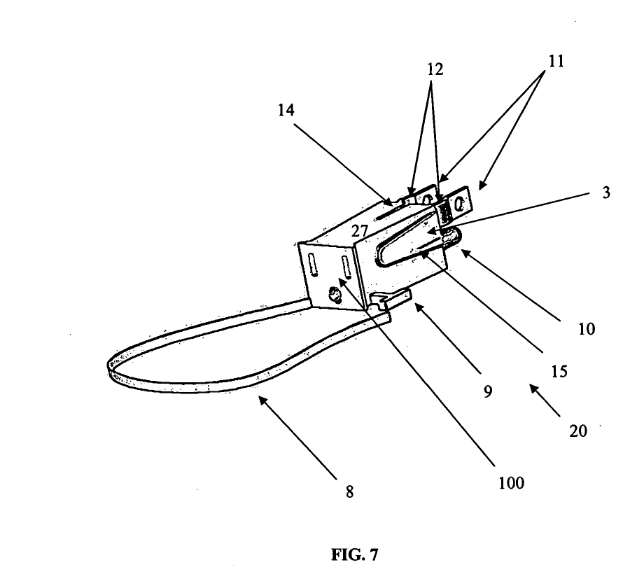

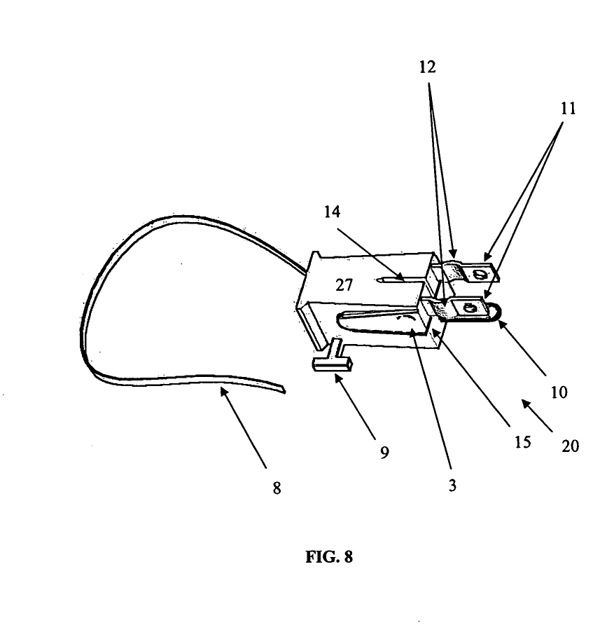

FIGS. 7 and 8 show another embodiment of the apparatus in accordance with the present invention in the form of an adapter 20. The adapter 20 may comprise a standard female electrical receptacle 100. The adapter 20 additionally comprises an electrical male plug with one or more of the above-described improvements, for example, prongs 11 having arches 12, and that may be spread and/or splayed from the standard spacing of the sockets (not shown) of an electrical power outlet (not shown). The body of the electrical male plug 27 may have the slits 14 and/or 15, as shown, or hollowed region 24, 34, or 44. As shown in FIGS. 7 and 8, the adapter 20 further comprises a flexible strap 8, for example, a shielded wire, that may be wrapped around a standard electrical male plug (not shown) and hook 9, after the standard electrical male plug has been inserted into the female electrical receptacle 100, in order to lock the standard electrical male plug to the adapter. The adapter 20 thus locks an electrical male plug lacking the earlier described improvements into the female electrical receptacle 100, and also increases tension between the male end of the adapter and the sockets of a standard electrical power outlet, thereby avoiding inadvertent disconnection or dislodgment of the plug through which electrical power is connected to an electrically powered device via an electrical cable (not shown).

FIG. 9 shows another embodiment of apparatus in accordance with the present invention to provide a locking female outlet 120. The female outlet 120 comprises a standard female electrical receptacle 100 and a flexible strap 8, for example, a shielded wire, that may be wrapped around a standard electrical male plug (not shown) and hook 9, after the standard male plug has been inserted into the female electrical receptacle 100, in order to lock the standard electrical male plug to the female receptacle. The locking female outlet 120 thus avoids unintended disconnection or dislodgment of the plug through which electrical power is connected to an electrically powered device via the electrical cable 6.

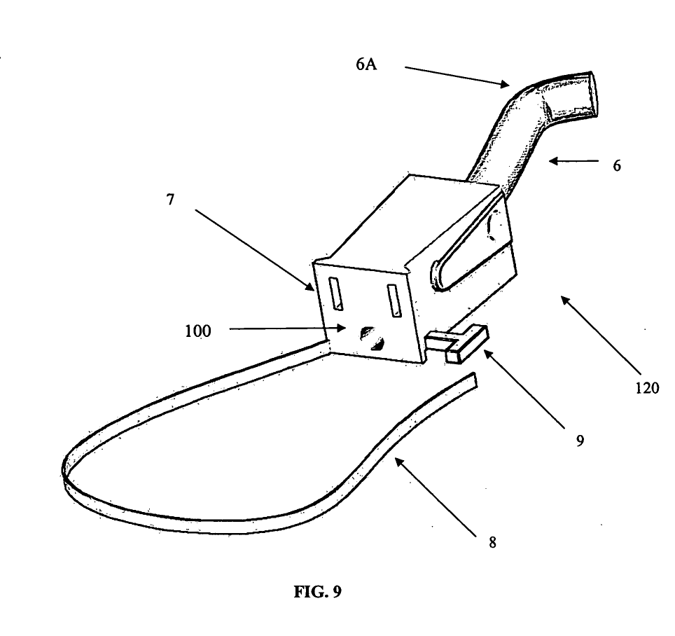

FIGS. 10 and 11 show an alternative embodiment of the present invention to provide a locking female outlet 121. The female outlet 121 comprises a standard female electrical receptacle 100 and a latch 122 attached to the body 123 via a hinge 124. After a standard electrical male plug (not shown) is inserted into the female electrical receptacle 100, the latch 122 may be closed by inserting a shank 125 through a hole 126 in the body 123 and into a hole (not shown) in a prong (not shown) of the standard electrical male plug. Thus, the prong (not shown) may not be removed from the female receptacle 100 unless the latch 122 is re-opened to unlock the standard electrical male plug (not shown) from the female receptacle. The locking female outlet 121 thus avoids unintended disconnection or dislodgment of the plug through which electrical power is connected to an electrically powered device via the electrical cable 6. It will also be appreciated by those skilled in the art that the locking mechanism 122 may be combined with an increased tension electrical male plug to provide the advantages described above in conjunction with FIGS. 7 and 8.

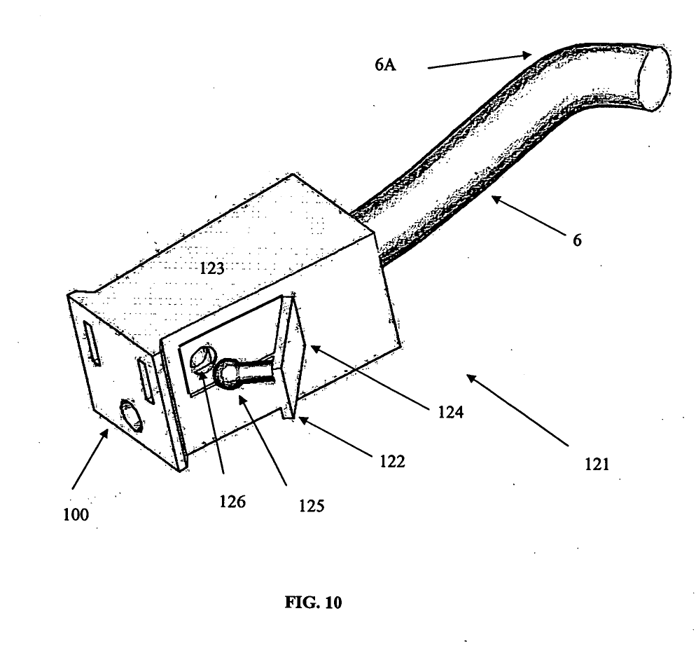

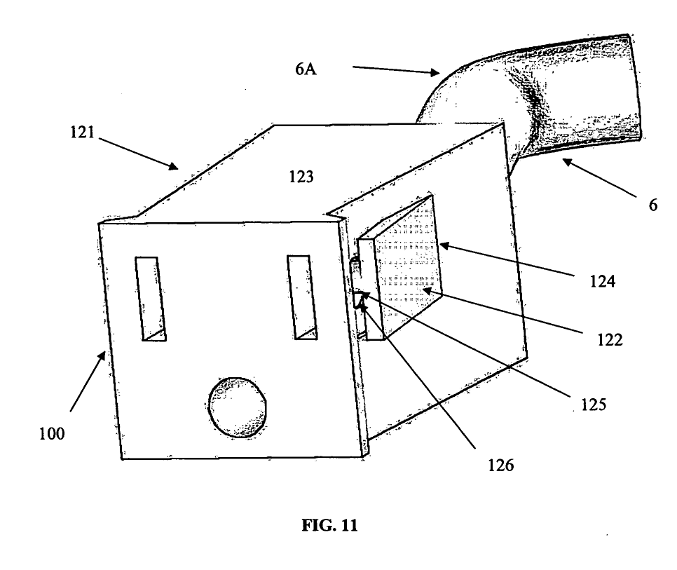

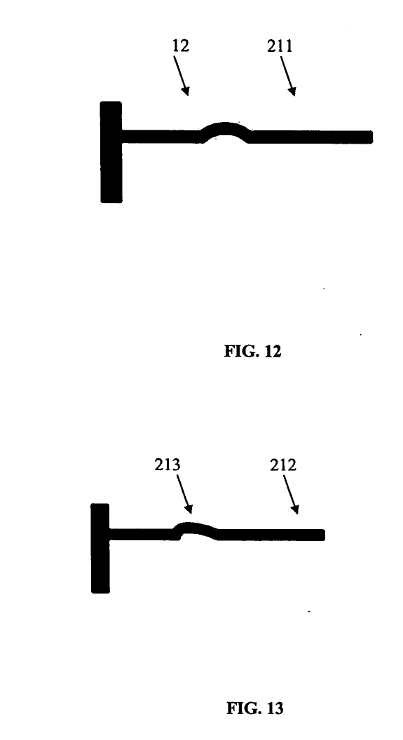

FIG. 12 is a top plan view of a prong 211 for incorporation into an electrical male plug body, for example, the male plug body 27 shown in FIG. 4. The prong 211 has a single arch 12. The arch 12 increases tension between the prong 211 and the socket of an electrical power outlet (not shown).

FIG. 13 is a top plan view of a prong 212 for incorporation into an electrical male plug body, for example, the male plug body 27 shown in FIG. 4. The prong 212 has a single asymmetrical arch 213. The arch 213 increases tension between the prong 212 and the socket of an electrical power outlet (not shown). The longer radius of the distal end of the arch 213 enables the prong 212 to more easily enter the socket of the electrical power outlet, while the shorter radius of the opposite end of the arch 213 increases tension with the socket of the electrical power outlet to avoid unintended disconnection or dislodgment of the plug through which electrical power is connected to an electrically powered device.

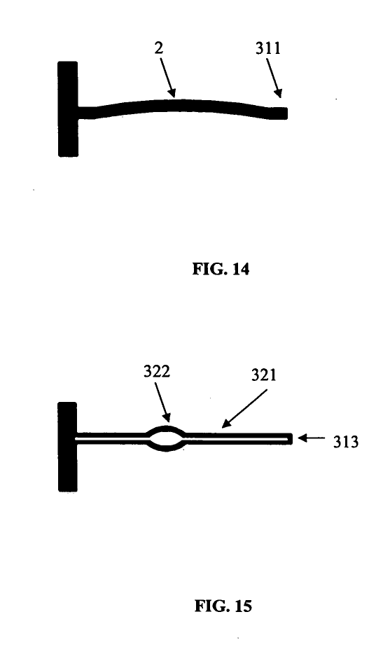

FIG. 14 is a top plan view of a prong 311 for incorporation into an electrical male plug body, for example, the male plug body 7 shown in FIG. 1. The entire prong 311 is recurved 2. The recurvature 2 increases tension between the prong 311 and the socket of an electrical power outlet (not shown).

FIG. 15 is a top plan view of a prong 321 for incorporation into an electrical male plug body. The prong 321 has opposite facing arches 322. A split 313 in the prong 321 is preferably constructed by a stamping manufacturing process by which a symmetrical stamp of conducting material is made and then folded upon itself to yield the configuration for the prong 321 shown in FIG. 15. The opposite facing arches 322 increase tension between the prong 321 and the socket of an electrical power outlet (not shown).

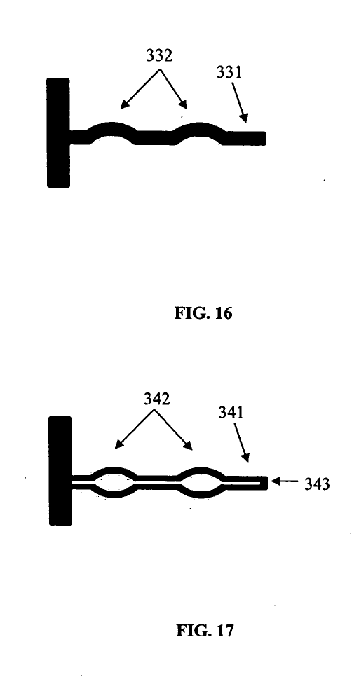

FIG. 16 is a top plan view of a prong 331 for incorporation into an electrical male plug body. The prong 331 has more than one arch 332. The arches 332 increase tension between the prong 331 and the socket of an electrical power outlet (not shown).

FIG. 17 is a top plan view of a prong 341 for incorporation into an electrical male plug body. The prong 341 has more than one set of opposite facing arches 342. A split 343 in the prong 341 is preferably constructed by a stamping manufacturing process by which a symmetrical stamp of conducting material is made and then folded upon itself to yield the configuration for the prong 341 shown in FIG. 17. The opposite facing arches 342 increase tension between the prong 341 and the socket of an electrical power outlet (not shown).

FIG. 18 is a top plan view of a ground prong 400 for incorporation into an electrical male plug body. The ground prong 400 has a set of opposite facing arches 412. The opposite facing arches 412 increase tension between the ground prong 400 and the ground socket of an electrical power outlet (not shown).

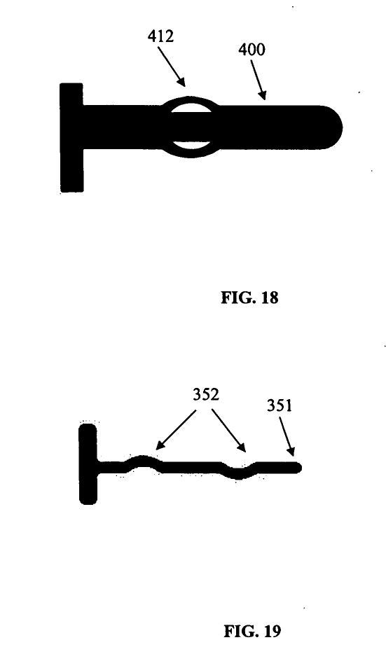

FIG. 19 is a top plan view of a prong 351 for incorporation into an electrical male plug body (not shown). The prong 351 has a set of spaced opposite facing arches 352. The opposite facing arches 352 increase tension between the prong 351 and the socket of the electrical power outlet (not shown).

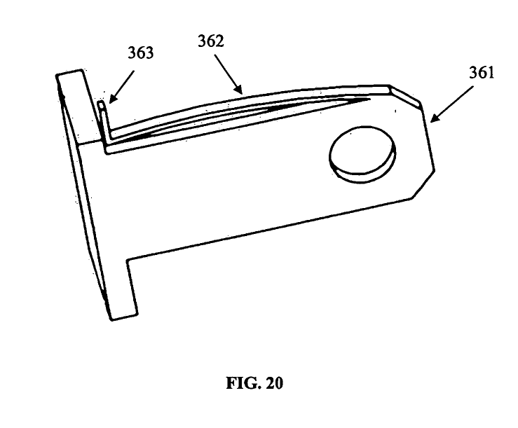

FIG. 20 is an isometric view of a prong 361 for incorporation into an electrical male plug body. The prong 361 has a single arch 362 disposed along an edge of the prong 361. The arch 362 is also preferably cantilevered from the prong 361 so that the arch may be depressed to enable the prong to be inserted into the socket of an electrical power outlet (not shown) to increase tension between the prong and the socket of the electrical power outlet. Preferably, the arch 362 has a lip 363 to prevent the end of the arch from being inserted into the socket of the electrical power outlet to avoid potentially locking onto and/or damaging the outlet.

The prongs shown in FIGS. 12-20 may be adapted to any electrical male plug body, as will be understood by persons skilled in the art. Furthermore, these prong configurations are indicative of the broad range of modifications to a prong that will increase tension between the electrical male plug and the socket of an electrical power outlet or female power receptacle.

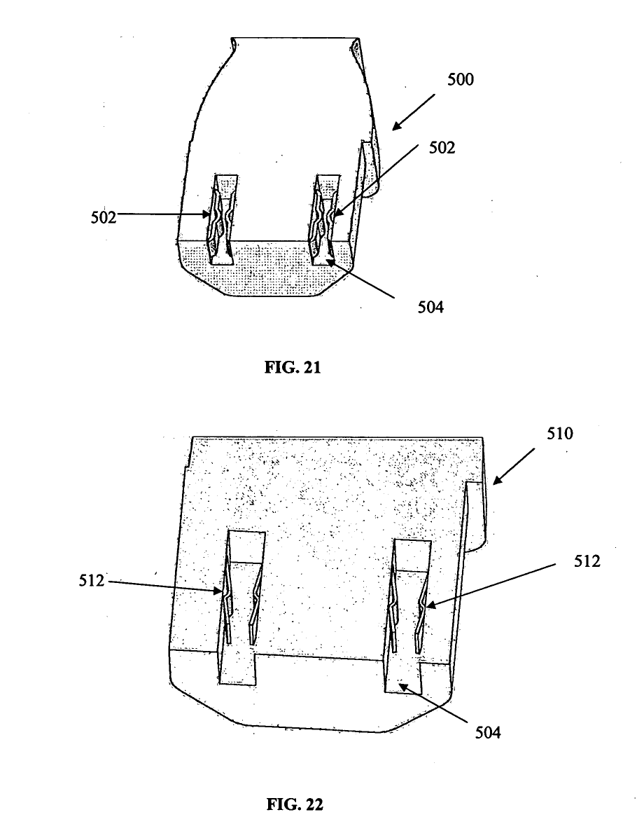

FIG. 21 is a cross-sectional view of an alternative embodiment of the apparatus in accordance with the present invention comprising an electrical female plug 500. The electrical female plug 500 comprises at least one and preferably two recurved or arched contacts 502 in each socket 504 of the plug. The recurving or arching of the contacts 502 increases tension between the prongs (not shown) an electrical male power connector (not shown).

FIG. 22 is a cross-sectional view of an alternative embodiment of the apparatus in accordance with the present invention comprising an electrical female plug 510. The electrical female plug 510 comprises at least one and preferably two cantilever contacts 512 in each socket 504 of the plug. The cantilever contacts 512 are arched or recurved and are preferably splayed inwardly at the distal end. The cantilever contacts 512 increase tension between the prongs (not shown) an electrical male power connector (not shown).

Tests of conventional electrical male plugs were performed using a standard electrical male plug having two power prongs and a ground prong inserted into the sockets of a standard electrical power outlet. Measurements were obtained for the force to remove the plug from the outlet. Based on these measurements, approximately five to eight pounds of force were required to remove the standard plug from the standard electrical power outlet.

Based on tests of electrically powered devices, an increase in the range of two to three times the removal force measured for the standard electrical male plug and standard electrical power outlet was found to substantially avoid unintended disconnection of electrical power. An electrical male plug having the configuration shown in FIG. 1 was tested to have a removal force of 10 to 25 pounds depending on the amount of recurvature 2. Consequently, the twofold to threefold increase in the removal force was achieved.

It is also contemplated that the electrical cable 6 may be expandable in length. In this case, the increased tension plug is used with a cable having elastic or extensible properties. For example, the cable 6 may be coiled along a portion of the length of the cable 6A to provide strain relief, as shown in FIGS. 5 and 9-11. The incorporation of a cable that is extendable in length provides advantages for various electrically powered devices such as vacuum cleaners and electrical leaf blowers and hedge trimmers, for example. Additionally, it is contemplated that a locking means may be provided that surrounds, ties around, clips onto, locks onto, or otherwise prevents unauthorized removal of the plug from the source of electrical power.

While the foregoing description has been with reference to particular embodiments of the present invention, it will be appreciated by those skilled in the art that changes in these embodiments may be made without departing from the principles and spirit of the invention, the scope of which is defined by the appended claims.

1. An electrical plug for substantially avoiding unintended disconnection of an external electrically powered device connected to the electrical plug, the electrical plug comprising:
a body; and
electrically conductive means disposed in the body for connection of an external source of electrical power to the electrically powered device, the electrically conductive means being configured to provide increased tension mechanical contact between at least one of a) the plug and the external electrical power source and b) the plug and the external electrically powered device.

2. The electrical plug according to claim 1 wherein the electrically conductive means is configured to provide increased tension mechanical contact between the plug and the external electrical power source, the electrically conductive means comprising:
at least two prongs having respective proximal ends disposed in the body and having respective distal ends adapted for insertion in an electrical power outlet, the proximal and distal ends being spanned by respective edges and longitudinal surfaces, at least one of the prongs being recurved or arched along at least one of the edges or longitudinal surfaces to increase tension between the at least one prong and a socket of the electrical power outlet.

3. The electrical plug according to claim 2 wherein at least one of the prongs has a roughened surface so that friction is increased between the at least one prong and the socket of the electrical power outlet into which the plug is selectively inserted.

4. The electrical plug according to claim 3 wherein the at least one prong is roughened by sandblasting, etching, machining, or casting to have a roughened surface or is provided with rounded, serrated, or non-planar edges.

5. The electrical plug according to claim 2 wherein the recurving or arching extends along only a portion of the prong.

6. The electrical plug according to claim 2 wherein the at least one prong comprises a plurality of recurved or arched portions spaced along the length of the at least one prong.

7. The electrical plug according to claim 6 wherein the at least one prong has opposite facing recurved portions or arches to increase tension between the at least one prong and the socket of the electrical power outlet.

8. The electrical plug according to claim 7 wherein the the opposite facing recurved portions or arches comprise the entire prong being formed as two opposite facing recurved portions or arches or the opposite facing recurved portions or arches extend over only a portion of the length of the prong such the remainder of the prong has a planar surface.

9. The electrical plug according to 2 wherein the at least one of prong comprises an asymmetric arch.

10. The electrical plug according to claim 1 wherein the electrically conductive means comprises:
an electrical male plug comprising at least two prongs splayed inwardly or outwardly to increase tension between the prongs and sockets of an electrical power outlet;
a spring mechanism that exerts a force on the prongs to splay the prongs; and
means for enabling a counterforce to be exerted on the spring mechanism to reduce the splaying of the prongs to enable the prongs to be more easily inserted into or removed from the electrical power outlet.

11. The electrical plug according to claim 10 wherein the body is constructed from resilient material and the spring mechanism results from the resilient characteristic of the material used in the construction of the body.

12. The electrical plug according to claim 11 wherein the means that exerts a counterforce on the spring mechanism to reduce the splaying of the prongs to enable the prongs to be more easily inserted into or removed from the sockets of the electrical power outlet comprises a portion of the body of the plug in contact with the resilient material adapted to be squeezed to compress the resilient material.

13. The electrical plug according to claim 1 wherein the electrically conductive means is configured to provide increased tension mechanical contact between the plug and the external electrically powered device, the electrically conductive means comprising:
at least two sockets disposed in the body adapted for insertion of male electrical contacts; and
female contacts disposed in at least one of the two sockets and configured to provide increased tension mechanical contact with at least one of the male electrical contacts.

14. The electrical plug according to claim 13 wherein the female contacts are recurved or arched to increase tension with at least one of the male electrical contacts.

15. The electrical plug according to claim 13 wherein the female contacts are cantilevered to increase tension with at least one of the male electrical contacts.

16. The electrical plug according to claim 1, further comprising an electrical cable that is expandable in length, the cable being connected at one end to the plug and at a second end to the external electrical power source or the external electrically powered device.

17. Apparatus for substantially avoiding unintended disconnection of an electrically powered device from an external source of electrical power, the electrically powered device being connected by an electrical cable attached at one end to the electrically powered device and at a second end to the external source of electrical power, the apparatus comprising:
a body attached to at least one of the ends of the electrical cable; and
electrically conductive means disposed in the body for connection of the external source of electrical power to the electrically powered device, the electrically conductive means being configured to provide increased tension mechanical contact in the range of 10 to 25 pounds between at least one of a) the apparatus and the external electrical power source and b) the apparatus and the external electrically powered device.

18. Apparatus that attaches to a standard electrical male plug at one end of an electrical cable attached at a second end to an electrically powered device, the apparatus comprising:
a body comprising a standard female receptacle at a first end, the receptacle comprising at least two sockets into which at least two prongs of the standard electrical plug are selectively inserted;
one of a) an electrical cable disposed at a second end of the body, the electrical cable being electrically coupled to the sockets of the receptacle, or b) electrically conductive means disposed at a second end of the body electrically coupled to the sockets of the receptacle, the electrically conductive means disposed in the body for connection of an external source of electrical power to the electrically powered device, the electrically conductive means being configured to provide increased tension mechanical contact between the electrically conductive means and an external source of electrical power; and
a locking mechanism to secure the standard electrical male plug to the apparatus.

19. The apparatus according to claim 18 wherein the locking mechanism comprises a strap and a hook mounted to the body for locking the standard electrical male plug to the apparatus.

20. The apparatus according to claim 18 wherein the locking mechanism comprises a latch mounted to the body for locking at least one prong of the standard electrical male plug to the apparatus.
